(19) United States
(12) Patent Application Publication
(10) Pub. No.: US 2005/0099815 A1
(43) Pub. Date: May 12, 2005

(54) Light guide plate and backlight assembly having the same

(75) Inventors: Dong-Hoon Kim, Suwon-si (KR); Jong-Dae Park, Seoul (KR); Kyu-Seok Kim, Yongin-si (KR); Jae-Ho Jung, Yongin-si (KR)

Correspondence Address: MCGUIREWOODS, LLP, 1750 TYSONS BLVD, SUITE 1800, MCLEAN, VA, 22102, US

(73) Assignee: Samsung Electronics Co., Ltd.

(21) Appl. No.: 10/792,090

(22) Filed: Mar. 4, 2004

(30) Foreign Application Priority Data
Nov. 8, 2003 (KR) 2003-78866

(51) Int. Cl. G02F 1/1335

(52) U.S. Cl. 362/339

(57) ABSTRACT

In a light guide plate and a backlight assembly having the same, the light guide plate includes side surfaces having at least one incident surface into which light is incident, an exit surface on which a first prism pattern for condensing the light and a concavo-convex pattern for diffusing the light are formed, and a reflect surface facing the exit surface and including a second prism pattern formed thereon. Accordingly, the backlight assembly may remove the diffusion and prism sheets therefrom and improve the light efficiency and brightness uniformity.

### CROSS-REFERENCE TO RELATED APPLICATION

This application claims priority upon Korean Patent Application No. 2003-78866 filed on Nov. 8, 2003, the contents of which are herein incorporated by reference in its entirety.

### BACKGROUND OF THE INVENTION

1. Field of the Invention

The present invention is directed to a light guide plate and a backlight assembly, and more particularly to a light guide plate that can change a linear light coming from a light source into a planar light and a backlight assembly having the same.

2. Description of the Related Art

Recently different types of computers have developed dramatically, devices have been rapidly developed with various architectures, functions and faster information processing speed. Such devices process information in an electrical signal format. In order to output the results processed in such devices, a display device usually interfaces within human beings.

A liquid crystal display (LCD) is lighter, smaller and can display high resolution image, consuming less power compared to the cathode ray tube (CRT) that has been used for a long time as display device. Now the LCD replaces the CRT in every industry.

In general, LCD device includes a display unit of an LCD panel and a backlight assembly. The backlight assembly supplies light to the LCD panel and displays images.

The backlight assembly includes a lamp and a light guide plate that guides the light coming from the lamp toward the LCD panel. Snell's law dictates the light coming from the lamp be totally reflected inside the light guide plate. The light leaking from the light guide plate because of a printed pattern formed at a bottom surface of the light guide plate, is reflected by a reflection plate disposed under the light guide plate, thereby advancing the scattered light through the light guide plate toward the LCD panel.

In order to improve uniformity and brightness of the light exiting from the light guide plate, the backlight assembly, further includes optical sheets, such as a diffusion sheet, a prism sheet and so on. The diffusion sheet diffuses the light and the prism sheet refracts and condenses the light.

The optical sheets increases the manufacturing costs for an LCD device. Also deteriation of the printed pattern of the light guide plate degrades display quality of the LCD device. In order to solve these problems, new optical sheets or light guide plate become necessary.

### BRIEF SUMMARY OF THE INVENTION

The present invention discloses a light guide plate that can diffuse and condense lights and enhance light efficiency and uniformity.

The present invention also discloses a backlight assembly using such a light guide plate.

According to the light guide plate and backlight assembly having the same, the light guide plate may perform various functions, for example, such as condensing the light using the prism pattern, diffusing the light using the concave-convex pattern. This eventually enhances the light efficiency and reduces manufacturing costs.

### BRIEF DESCRIPTION OF THE DRAWINGS

The above and other advantages of the present invention will become readily apparent by reference to the following detailed description when considered in conjunction with the accompanying drawings.

FIG. 1 is a perspective view showing a light guide plate according to an exemplary embodiment of the present invention.

FIG. 2 is a perspective view showing a rear surface of the light guide plate shown in FIG. 1.

FIG. 3 is a cross-sectional view taken along the line A-A′ of FIG. 1.

FIG. 4 is a cross-sectional view taken along the line B-B′ of FIG. 1.

FIG. 5 is a perspective view showing the first prisms shown in FIG. 3.

FIG. 6 is a perspective view showing a concavo-convex pattern according to another exemplary embodiment of the present invention.

FIG. 7 is a perspective view showing a second prism shown in FIG. 4.

FIG. 8 is a perspective view showing a second prism pattern according to another exemplary embodiment of the present invention.

FIG. 9 is an exploded perspective view showing a backlight assembly according to an exemplary embodiment of the present invention.

FIG. 10 is an exploded perspective view showing a liquid crystal display apparatus according to an exemplary embodiment of the present invention.

### DETAILED DESCRIPTION OF THE INVENTION

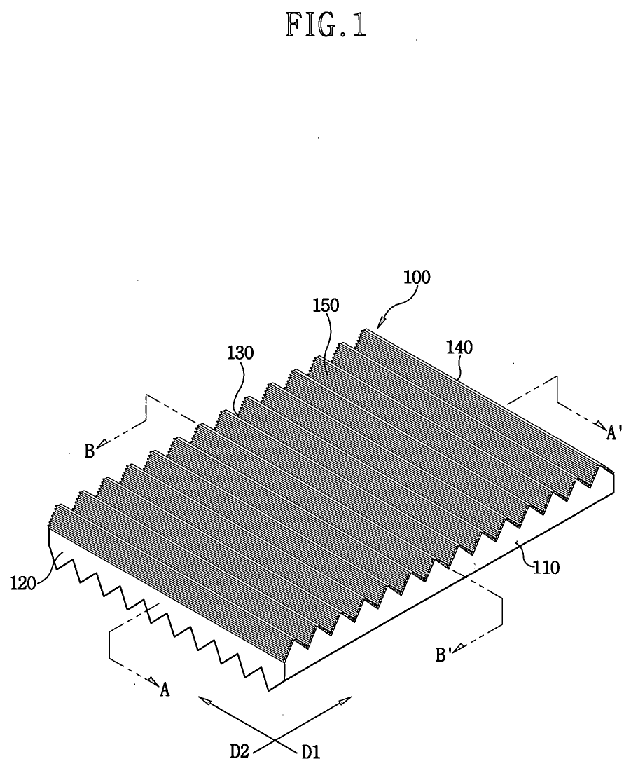

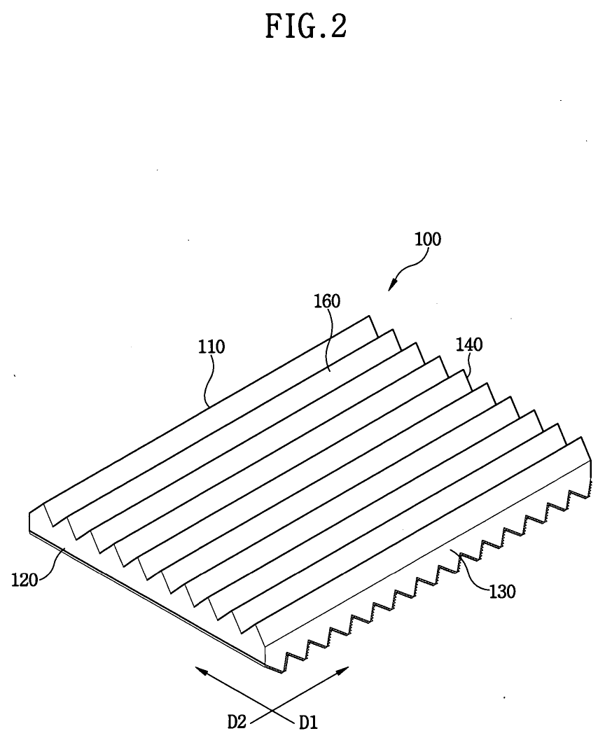

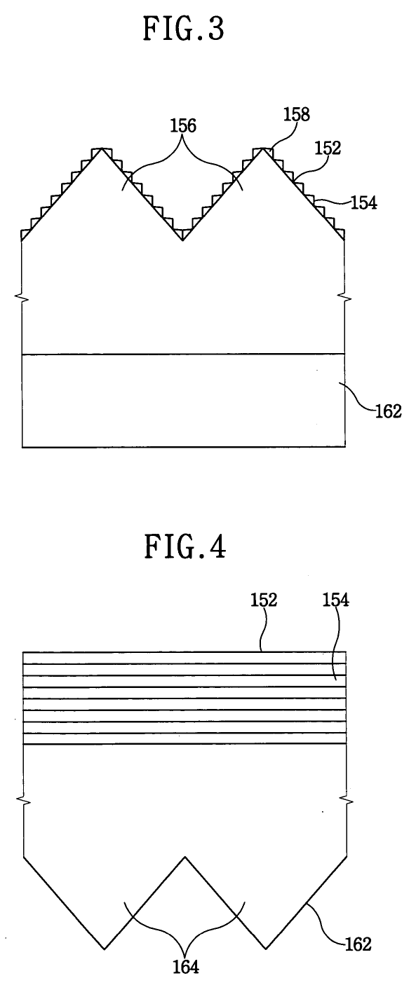

FIG. 1 is a perspective view showing a light guide plate according to an exemplary embodiment of the present invention. FIG. 2 is a perspective view showing a rear surface of the light guide plate shown in FIG. 1. FIG. 3 is a cross-sectional view taken along the line A-A′ of FIG. 1. FIG. 4 is a cross-sectional view taken along the line B-B′ of FIG. 1.

Referring to FIGS. 1, 2, 3 and 4, a light guide plate 100 according to an exemplary embodiment of the present invention includes first, second, third and fourth side surfaces 110, 120, 130 and 140, an exist surface 150 and a reflect surface 160.

A lamp is disposed adjacent to at least one side surface among the first, second, third and fourth side surfaces 110, 120, 130 and 140. In this exemplary embodiment, the lamp may be disposed adjacent to the first side surface 110 and the third side surface 130. The first side surface 110 or third side surface 130 where the lamp light comes in is called an incident surface.

The exist surface 150 includes a first prism pattern 152 that condenses the light and a concavo-convex pattern 154 that diffuses the light. This enables the light coming through the incident surfaces 110 and 130 to exit through the exit surface 150.

Particularly, the first prism pattern 152 has a plurality of first prisms 156 parallel to each other on the exist surface 150. Each of the first prisms 156 has a triangular prism shape extended in a first direction D1 substantially perpendicular to the incident surfaces 110 and 130. The first prisms 156 condense the light coming through the exist surface 150 so as to emit the condensed light toward a front direction.

The concavo-convex pattern 154 having a plurality of concavo-convex portions 158 protruded from the first prisms 156 in a predetermined height is formed on the exist surface 150. The concavo-convex portions 158 having a uniform pattern are extended in the first direction D1, and formed over the first prisms 156. The concavo-convex portions 158 diffuse the light coming from the first prisms 156.

The reflect surface 160 faces the exit surface 150 and includes a second prism pattern 162. The second prism pattern 162 includes a plurality of second prisms 164 substantially parallel to each other, and is formed over the reflect surface 160. Each of the second prisms 164 has a triangular prism shape extended in the second direction D2, and runs in a direction substantially perpendicular to the first prisms 156 formed on the exit surface 150. The second prism pattern 162 reflects the light coming onto the reflect surface 160 to the exit surface 150.

Hereinafter, the exit surface 150 and reflect surface 160 of the light guide plate 100 will be described in detail with reference to the accompanying drawings.

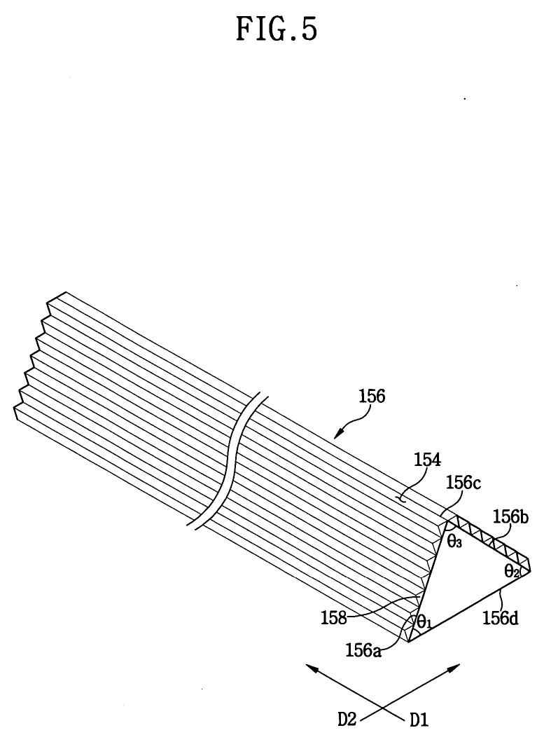

FIG. 5 is a perspective view showing the first prisms shown in FIG. 3.

Referring to FIG. 5, the first prisms 156 formed on the exit surface 150 is protruded from a surface 156d substantially perpendicular to an end of the incident surfaces 110 and 130.

Particularly, each of the first prisms 156 includes a first surface 156a inclined with respect to the surface 156d at a first angle θ1 and a second surface 156b inclined with respect to the surface 156d at a second angle θ2. The surface 156d runs substantially parallel with the incident surfaces 110 and 130. The first surface 156a and the second surface 156b are is connected to each other so as to provide a first ridge 156c. The first angle θ1 and the second angle θ2 are the same. Thus, each of the first prisms 156 has a cross-section of an isosceles triangle shape and the triangular prism shape extended in the first direction D1.

An internal angle θ3 between the first surface 156a and second surface 156b is obtuse and between about 100° and about 120°.

The first surface 156a and the second surface 156b of the first prisms 156 further include the concavo-convex pattern 154 that diffuses the light coming from the first prisms 156.

Particularly, the concavo-convex pattern 154 includes the concavo-convex portions 158 protruded from the first surface 156a and the second surface 156b in a predetermined height. Each of the concavo-convex portions 158 has the triangular prism shape extended in the first direction D1, and is uniformly formed over the first surface 156a and the second surface 156b. The concavo-convex portions 158 may have a rounded corner.

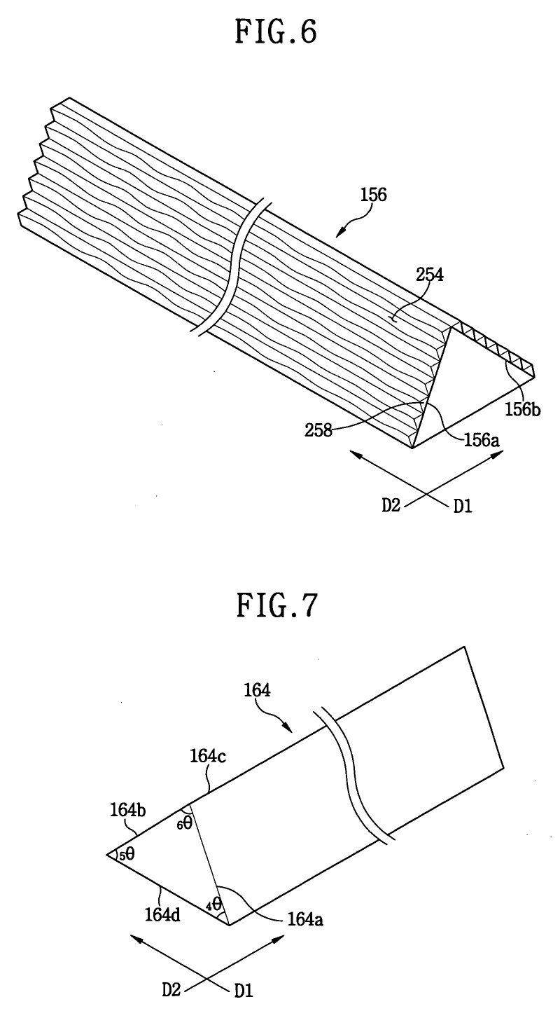

FIG. 6 is a perspective view showing a concavo-convex pattern according to another exemplary embodiment of the present invention.

Referring to FIG. 6, a concavo-convex pattern 254 includes a plurality of concavo-convex portions 258 protruded from a first surface 156a and a second surface 156b of first prisms 156.

Each of the concavo-convex portions 258 is extended in the first direction D1, and is formed over the first surface 156a and the second surface 156b. In this exemplary embodiment, each of the concavo-convex portions 258 has a ridge extended in the first direction D1 and curved in a predetermined curvature, and a groove where a concavo-convex portion meets an adjacent concavo-convex portion may be parallel to each other, thereby improving diffusibility of the concavo-convex portions 258.

As an exemplary embodiment, the concavo-convex pattern has been described with reference to FIGS. 5 and 6. However, the concavo-convex pattern may be transformed into various shapes so as to diffuse the light coming from the first surface 156a and the second surface 156b. For example, each of the concavo-convex portions 258 may have a ridge curved in the predetermined curvature and having a non-uniform height while the ridge is extended in the first direction D1.

The concavo-convex pattern 254 may be formed by a hologram method. The hologram method uses two lasers of different phrases. The different phase between the two lasers generates an interference pattern, which can be used to fabricate a core having the concavo-convex pattern. After manufacturing a stamper using the core fabricated by the hologram method, the concavo-convex pattern may be formed by a molding method using the stamper, for example, such as an injection molding, a pressure molding and so on.

In this exemplary embodiment, the light guide plate 100 includes a second prism pattern 162 formed on a reflect surface 160.

FIG. 7 is a perspective view showing a second prism shown in FIG. 4. The second prism pattern 162 is formed on the reflect surface 160 and includes a plurality of second prisms 164. Each of the second prisms 164 is protruded from a surface 164d that runs substantially perpendicular to an opposite end of the incident surfaces 110 and 130.

Particularly, each of the second prisms 164 includes a third surface 164a inclined with respect to the surface 164d at a fourth angle θ4 and a fourth surface 164b inclined with respect to the surface 164d at a fifth angle θ5. The third surface 164a and the fourth surface 164b abut to each other and provides a second ridge 164c. The fourth angle θ4 and the fifth angle θ5 are the same, and the third surface 164a has a same length as the fourth surface 164b. Thus, each of the first prisms 164 has a cross-section of an isosceles triangle shape and the triangular prism shape extended in the second direction D2.

An internal angle θ6 between the third surface 164a and the fourth surface 164b is greater than 90°, and is from about 120° to about 140°.

In order to improve uniformity of the light coming from the exit surface 150, the second prism pattern 162 formed on the reflect surface 160 may have various shapes.

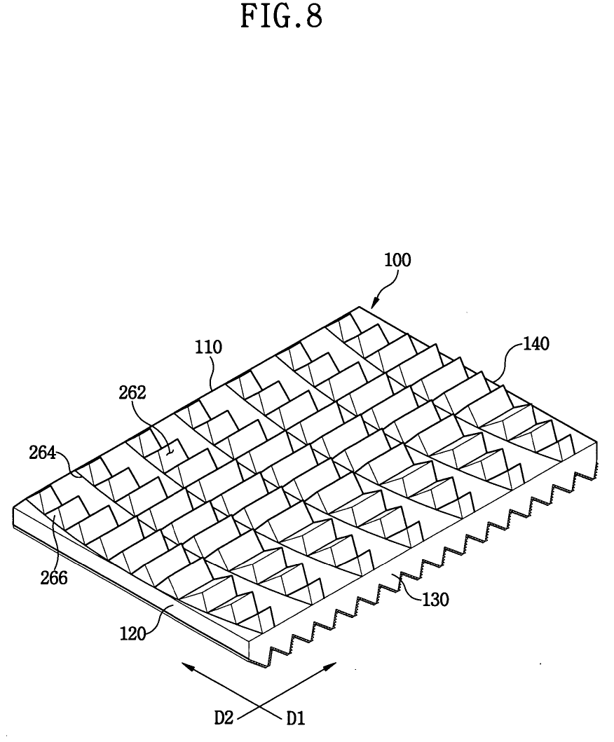

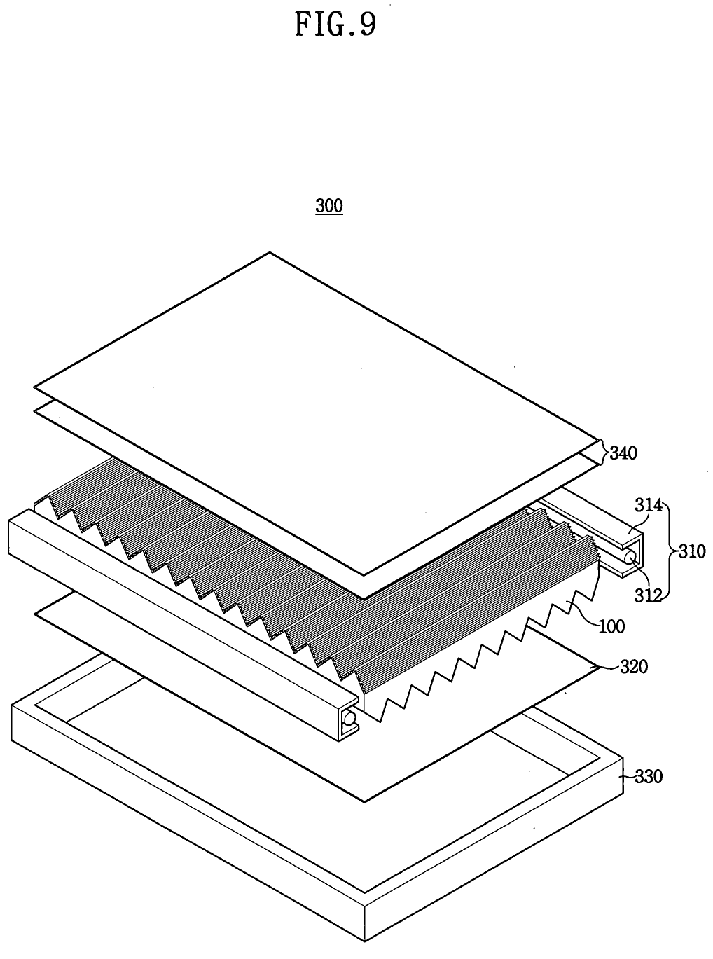

FIG. 8 is a perspective view showing a second prism pattern according to another exemplary embodiment of the present invention. In FIG. 8, a second prism pattern 262 includes a plurality of light amount control patterns 264. The light amount control patterns 264 are arranged in the second direction D2 and spaced apart from each other in a predetermined distance.

Particularly, the light amount control patterns 264 include a plurality of fourth prisms 266. Each of the fourth prisms 266 has a triangular prism shape extended in the first direction D1 and arranged in the second direction D2 substantially perpendicular to the incident surfaces 110 and 130. In this exemplary embodiment, since each of the fourth prisms 266 has the triangular prism shape same as those of when each of the second prisms 164 is cut into a plurality of pieces, descriptions in connection with the shape of the fourth prisms 266 will be omitted.

The light amount control patterns 264 that are located farther apart from the incident surfaces 110 and 130 is wider than that located closer to the incident surfaces 110 and 130. When the lamp disposed adjacent to the incident surfaces 110 and 130 of the light guide plate 100 emits light, the fourth prisms 266 formed at a center portion of the light guide plate 100 reflects more light, because the center prisms have longer length than those at both ends adjacent to the incident surfaces 110 and 130. In this exemplary embodiment, the length means an extended length of the fourth prisms 266 in the first direction D1 and gradually increases from the incident surfaces 110 and 130 toward the center portion of the light guide plate 100. The light amount control patterns 264 reflect the light incident through the incident surfaces 110 and 130 to the center portion to improve the uniformity of the light coming through the exit surface 150. Also, depending on a position and a characteristic of the lamp supplying the light to the is light guide plate 100, the light amount control patterns 264 may have different shapes.

The light guide plate 100 may provide improved brightness by adjusting the third angle θ3 of the first ridge 156c and the sixth angle θ6 of the second ridge 164c.

Brightness characteristics measured in accordance with variations of the third angle θ3 of the first ridge 156c and the sixth angle θ6 of the second ridge 164c is shown in Table 1.

TABLE 1

| | | | |
|---|---|---|---|
| The internal angle of the first ridge (⊖3) | 82° | 90° | 108° |
| The internal angle of the second ridge (⊖6) | 68° | 90° | 135° |
| Brightness of the backlight assembly (nit) | 2101 | 2683 | 2864 |
| Brightness of the liquid crystal | 225.7 | 266.2 | 281.6 |
| display panel (nit) | | | |

In Table 1, the brightnesses of the backlight assembly and liquid crystal display panel have been measured with respect to each of cases that the third angle θ3 and sixth angle θ6 are 90°, smaller than 90° and greater than 90°.

The measurement shows that the third angle θ3 and sixth angle θ6 of bigger than 90° shows higher brightness of the backlight assembly and liquid crystal display panel than those of the backlight assembly and liquid crystal display panel when the third angle θ3 and sixth angle θ6 of lower than 90°. Especially, the combination of the third θ3 of 108° and the sixth angle θ6 of 135°, respectively, improves the backlight assembly and liquid crystal display panel brightness by about 6.7% and about 5.8%, respectively, than in the case that both of the third and sixth angles θ3 and θ6 are 90°.

The first prism pattern 152 formed at the exit surface 150 and the second prism pattern 162 formed at the reflect surface 160 may have different shapes. That is, the first prisms 156 may be extended in the second direction D2 substantially parallel to the incident surfaces 110 and 130, and the second prisms 164 may be extended in the first direction D1 substantially perpendicular to the incident surfaces 110 and 130. In some cases, the first prisms 156 and second prisms 164 may be extended in a same direction depending on the required brightness characteristics.

Hereinafter, a backlight assembly and a liquid crystal display apparatus having the backlight assembly will be described.

FIG. 9 is an exploded perspective view showing a backlight assembly according to an exemplary embodiment of the present invention. In FIG. 9, the same reference numerals denote the same elements in FIGS. 1 through 8, and thus the detailed descriptions of the same elements will be omitted.

Referring to FIG. 9, a backlight assembly 300 includes a lamp unit 310 for emitting light and a light guide plate 100 for guiding the light provided from the lamp unit 310 so as to direct the light to a predetermined direction.

The lamp unit 310 includes at least one lamp 312 for emitting light and a lamp reflector 314 for reflecting the light coming from the lamp 312 to the light guide plate 100. The lamp unit 310 may be disposed adjacent to one end or both ends facing each other of the light guide plate 100. In this exemplary embodiment, the lamp unit 310 is disposed adjacent to both ends facing each other of the light guide plate 100.

The lamp 312 includes a cold cathode fluorescent lamp (CCFL) having a bar shape. The lamp reflector 314 may be formed of material of high reflectivity or formed by coating a reflecting member onto a cover of the lamp 314. The lamp reflector 314 reflects the light emitted from the lamp 312 to the light guide plate 100 and improves light efficiency.

As shown in FIGS. 1 through 8, the light guide plate 100 includes a first side surface 110, a second side surface 120, a third side surface 130 and a fourth side surface 140. At least one of those as the incident surfaces 110 or 130. The light emitted from the lamp 312 goes into the incident surface and comes out through the exit surface 150. The exit surface includes the first prism pattern 152 having the first prisms 156 parallel to each other and the concavo-convex pattern 154 formed at the first prisms 156. The light guide plate also has a reflect surface 160 facing the exit surface 150. The reflect surface has the second prism pattern 162 formed thereon.

The backlight assembly 300 further includes a reflecting plate 320 disposed under the reflect surface 160. The reflecting plate reflects the light leaking through the reflect surface 160, and a receiving container 330 for receiving the reflecting plate 320, light guide plate 100 and lamp unit 310.

The reflecting plate 320 is a sheet of reflecting material with a size corresponding to the reflect surface 160. The reflecting plate 320 is disposed between the reflect surface 160 and receiving container 330. The receiving container 330 may be formed of a mold frame, or further include a bottom chassis (not shown) so as to strengthen the backlight assembly 300.

Also, the backlight assembly 300 further includes at least one optical sheet 340 disposed on the exit surface 150 of the light guide plate 100 so as to improve brightness characteristics of the light coming through the exit surface 150.

The optical sheet 340, generally, includes optical sheets, for example, such as a diffusion sheet for diffusing the light, a prism sheet for refracting and condensing the light and so on. Depending on the brightness characteristics, one of the optical sheets may be added or removed from the backlight assembly 300.

Brightness characteristics of the backlight assembly according to the exemplary embodiment of the present invention are compared with a conventional backlight assembly as shown in Table 2.

TABLE 2

| | Conventional | Backlight |
|---|---|---|
| | backlight | assembly of the |
| | assembly | present invention |
| 25 points average brightness (nit) | 2678 | 2859 |
| 13 points average brightness (nit) | 2675 | 2878 |
| Center point brightness (nit) | 2982 | 3138 |
| 25 points brightness comparison (%) | 100 | 106.7 |
| 25 points uniformity (%) | 77.8 | 75 |
| 13 points uniformity (%) | 77.8 | 79.3 |

In Table 2, the conventional backlight assembly includes a light guide plate is having a flat exit surface and a flat reflect surface and an optical sheet having two diffusion sheets and one prism sheet. Also, the backlight assembly of the present invention includes the light guide plate 100 shown in FIG. 8 and an optical sheet having one diffusion sheet and one prism sheet.

As represented by Table 2, according to the measurement of the brightness with respect to 25 points, 13 points or a center point of the conventional backlight assembly and the backlight assembly 300 of the present invention, the backlight assembly of the present invention shows brightness higher than the conventional backlight assembly. Especially, in the average brightness with respect to 25 points, the backlight assembly 300 of the present invention shows 6.7% improvement.

Also, in the brightness uniformity, the backlight assembly 300 of the present invention is substantially same as the conventional backlight assembly.

Thus, although the backlight assembly 300 of the present invention includes one diffusion sheet, the backlight assembly 300 of the present invention may provide the improved brightness of about 6.7% compared with the conventional backlight assembly.

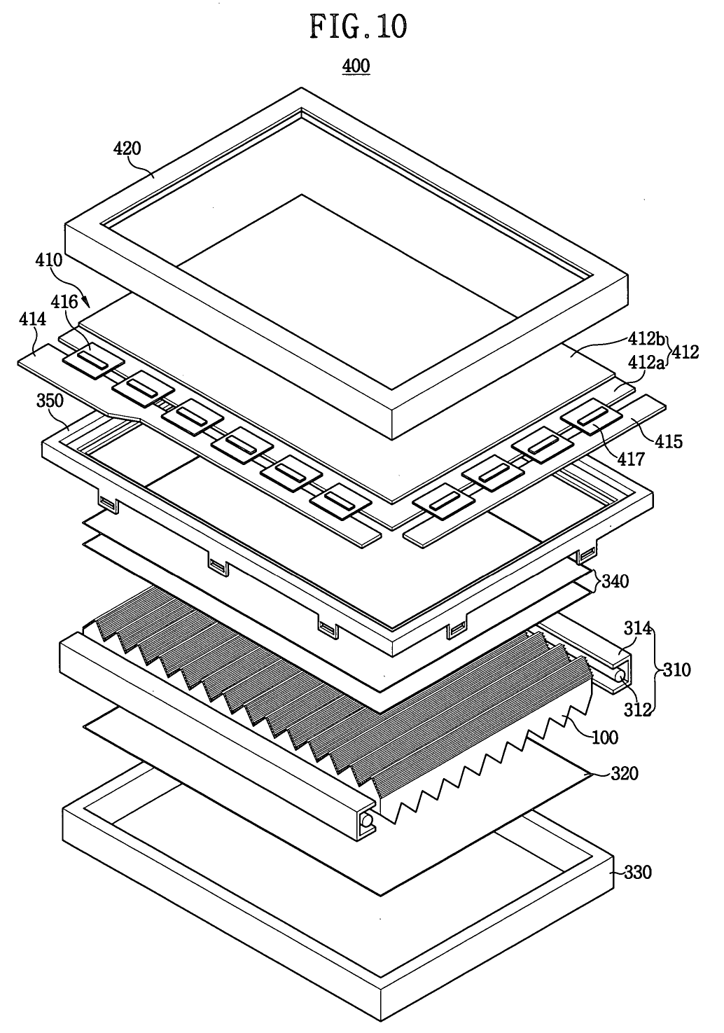

FIG. 10 is an exploded perspective view showing an LCD apparatus according to an exemplary embodiment of the present invention. In FIG. 10, the same reference numerals denote the same elements in FIG. 9, and thus the detailed descriptions of the same elements will be omitted.

Referring to FIG. 10, an LCD apparatus 400 includes a display unit 410 for displaying an image, a backlight assembly 300 for supplying the light to the display unit 410 and a top chassis 420 for fixing the display unit 410 to the backlight assembly 300.

The display unit 410 includes an LCD panel 412 for displaying the image, data printed circuit board (PCB) 414 and gate printed circuit board (PCB) 415 for providing driving signals to the LCD panel 412. The data PCB 414 and the gate PCB 415 are electrically connected to the LCD panel 412 by data tape carrier package (TCP) 416 and gate tape carrier package (TCP) 417.

The LCD panel 412 includes a thin film transistor (TFT) substrate 412a, a color filter substrate 412b combined with the TFT substrate 412a, and a liquid crystal layer (not shown) interposed between the TFT substrate 412a and color filter substrate 412b.

The TFT substrate 412a is a transparent glass substrate on which TFTs are formed in a matrix configuration. Each of the TFTs includes a source terminal connected to a data line, a gate terminal connected to a gate line and a drain terminal connected to a pixel electrode (not shown) of a transparent conductive material.

The color filter substrate 412b includes red, green and blue pixels (not shown) formed thereon through a thin film process. The color filter substrate 412b further includes a common electrode (not shown) of a transparent conductive material.

The display unit 410 is disposed on a middle mold 350 for fixing the optical sheet 340 to the receiving container 330, and fixed to the middle mold 350 by coupling the top chassis 420 to the receiving container 330.

According to the light guide plate and backlight assembly, the prism pattern and concavo-convex pattern are formed on the exit surface and the reflect surface of the light guide plate so as to diffuse and condense the light. This removes the diffusion and prism sheets from the backlight assembly and improves the light efficiency and brightness uniformity.

Although the exemplary embodiments of the present invention have been is described, it is understood that the present invention should not be limited to these exemplary embodiments but various changes and modifications can be made by one of ordinary skill in the art within the spirit and scope of the present invention as hereinafter claimed.

1. A light guide plate, comprising:
a first surface having a first light control pattern; and
a second surface having a second light control pattern,
wherein said first surface faces said second surface.

2. The light guide plate of claim 1, further comprising:
a third surface;
a fourth surface;
a fifth surface; and
a sixth surface.

3. The light guide plate of claim 2, wherein the first light control pattern is a first prism pattern.

4. The light guide plate of claim 3, wherein the first prism pattern comprises a plurality of first prisms aligned in a row to a first direction.

5. The light guide plate of claim 4, wherein the plurality of first prisms have a triangular cross-sectional shape.

6. The light guide plate of claim 5, wherein the triangular cross-sectional shape is an equilateral triangle.

7. The light guide plate of claim 5, wherein the triangular cross-sectional shape has a vertex angle ranging between 100° and 120°.

8. The light guide plate of claim 7, wherein the vertex angle is 108°.

9. The light guide plate of claim 5, wherein the plurality of first prisms have a first prism surface and a second prism surface, and
wherein the first prism surface and the second prism surface includes a concavo-convex pattern.

10. The light guide plate of claim 9, wherein the concavo-convex pattern has a triangular prism shape.

11. The light guide plate of claim 9, wherein the concavo-convex pattern has a rounded corner.

12. The light guide plate of claim 2, wherein at least one of the third surface, the fourth surface, the fifth surface and the sixth surface is a light incident surface.

13. The light guide plate of claim 12, wherein the second light control pattern is a second prism pattern.

14. The light guide plate of claim 13, wherein the second prism pattern comprises a plurality of second prisms aligned in a row to a second direction.

15. The light guide plate of claim 14, wherein the second direction is parallel with the light incident surface.

16. The light guide plate of claim 15, wherein the first light control pattern comprises a first prism pattern with a plurality of first prisms aligned in a row to a first direction, and wherein the first direction is perpendicular to the second direction.

17. A liquid crystal display, comprising:
a liquid crystal display panel;
a backlight assembly; and
a module that accommodates said liquid crystal display panel and said backlight assembly,
wherein said backlight assembly comprises:
a light guide plate comprising;
a first surface having a first light control pattern; and
a second surface having a second light control pattern,
wherein the first surface faces the second surface.

18. The liquid crystal display of claim 17, wherein the first light control pattern is a first prism pattern comprising a plurality of first prisms aligned in a row to a first direction,
wherein the second light control pattern is a second prism pattern comprising a plurality of second prisms aligned in a row to a second direction, and
wherein the first direction is perpendicular to the second direction.

19. The liquid crystal display of claim 18, wherein the plurality of first prisms have a triangular cross-sectional shape, and
wherein the triangular cross-sectional shape has a vertex angle ranging between 100° and 120°.

20. The liquid crystal display of claim 18, wherein the plurality of first prisms has a first prism surface and a second prism surface that include a concavo-convex pattern.
